(19) United States
(12) Patent Application Publication
(10) Pub. No.: US 2015/0001838 A1
(43) Pub. Date: Jan. 1, 2015

(54) Magnetic Vehicle Body Panel Protector

(71) Applicant: Roman Moroz, Etobicoke (CA)

(72) Inventor: Roman Moroz, Etobicoke (CA)

(21) Appl. No.: 13/930,798

(22) Filed: Jun. 28, 2013

(51) Int. Cl. B60R 13/04

(52) U.S. Cl. CPC B60R 13/04
USPC 280/770

(57) ABSTRACT

The present invention provides a magnetic flexible and trimmable vehicle body panel protector sheet used to protect a vehicle body panel from scratches and abrasions to the body panel and finish. The protector comprises a magnetic sheet that adheres to a vehicle's metal body panel by magnetic force. The protector also comprises a magnetic sheet that is flexible to adapt to the contour of a vehicle body panel. The protector sheet is trimmable to adapt to the contour and fit around objects that may be affixed to the vehicle body panel, to ensure the entire magnetic surface of the protector adheres to a vehicle body panel.

### FIELD OF THE INVENTION

The present invention relates to a ferrous metal vehicle body panel protector and more particularly to a flexible and trimmable magnetic sheet applied to a ferrous metal vehicle body panel to protect the body panel and finish.

### BACKGROUND OF THE INVENTION

Pets that enjoy riding in vehicles are often seen with their paws, legs or feet protruding through an open vehicle window and resting on the edge of a vehicle door. Vehicle body panels are often scratched or marked by pets that rest their extremities such as paws, legs or feet with nails on a vehicle body panel while they are transported in the vehicle. Often dogs and other animals will place their paws, legs or feet on a vehicle door panel through an open window and as a result of the movement of the paws, legs or feet on the door, the door and finish on the door may be scratched and marked. Dogs that ride in the bed of a pickup track may rest their paws on the body panel surrounding the pickup truck bed and scratch or mark the body panels and finish.

People often rest their arms on a vehicle door panel by protruding their arm through an open window. When a person is wearing a watch or jewellery, the watch or jewellery may scratch the door panel and finish resulting in damage to the vehicle. Also, the oils and sweat from a person's arm can discolor and fade a vehicle body panels finish over time.

Vehicle owners spend time and money on products to keep the appearance of their vehicle aesthetically pleasing and retain the value of the vehicle. A vehicle body panel that has scratches and abrasions is not aesthetically pleasing and may require costly repairs to the vehicle body panel and finish, and may drastically reduce the value of the vehicle.

A magnetic flexible and trimmable vehicle body panel protector that can adhere to the ferrous metal vehicle body panel without the need for mechanical adhesion and that will adhere to a vehicle body panel while the vehicle travels at highway speed is thus highly desirable.

Therefore, it is an objective of the invention to provide a ferrous metal vehicle body panel protector to mitigate and obviate the problems mentioned above.

### SUMMARY AND OBJECTIVES OF THE INVENTION

The present invention provides a magnetic sheet that can adhere to a vehicle's ferrous metal body panel by magnetic force and stay adhered to the vehicle body panel at highway speed.

An objective of the present invention is to provide a magnetic sheet protector that is flexible and will conform to the contours of a vehicle body panel to protect the vehicle body panel from scratches and abrasions caused by animals and humans.

Another objective of the protector is to be trimmable to allow the protector to be trimmed around objects that may protrude from the vehicle body panel, like a car door handle on a car door, thus allowing the entire surface of the protector to adhere to the vehicle body so as not to allow air to pass under the protector and disengage the protector from the vehicle body panel while the vehicle is in motion.

A further objective of the protector is to provide a protector that can be removed easily from the vehicle body panel to facilitate cleaning of the vehicle and protector.

A further objective of the protector is to protect the vehicle body panel's aesthetic appearance.

A further objective of the protector is to provide a non abrasive surface for animals and humans to rest their paws, legs and feet and in the case of humans, their arms.

A further objective of the protector is to protect the vehicle body panel's finish.

A further objective of the protector is to reduce the aerodynamic drag of the protector when applied to a vehicle, by use of rounded corners.

A further objective of the protector is to provide a surface for the application of a decorative visual design, graphic image and company brand or logo.

### BRIEF DESCRIPTION OF THE DRAWINGS

An embodiment of the present invention and how it may be put into effect, by way of example, can be better understood by referring to the accompanying drawing in which:

FIG. 1 is a perspective front view showing the protector in accordance with the present invention;

FIG. 2 is a front view showing the protector in accordance with the present invention;

FIG. 3 is a back view showing the protector in accordance with the present invention;

FIG. 4 is a top view showing the protector in accordance with the present invention;

FIG. 5 is a bottom view showing the protector in accordance with the present invention;

FIG. 6 is a left side view showing the protector in accordance with the present invention;

FIG. 7 is a right side view showing the protector in accordance with the present invention;

FIG. 8 is a detailed perspective front view showing one embodiment of the present invention, the protector with rounded corners and a decorative visual design, company logo and brand applied.

FIG. 9 is a detailed perspective front view showing another embodiment of the present invention, the protector applied to a vehicle door and trimmed to conform to the contour of the car door and to fit around the car door handle.

### DETAILED DESCRIPTION OF THE EMBODIMENTS

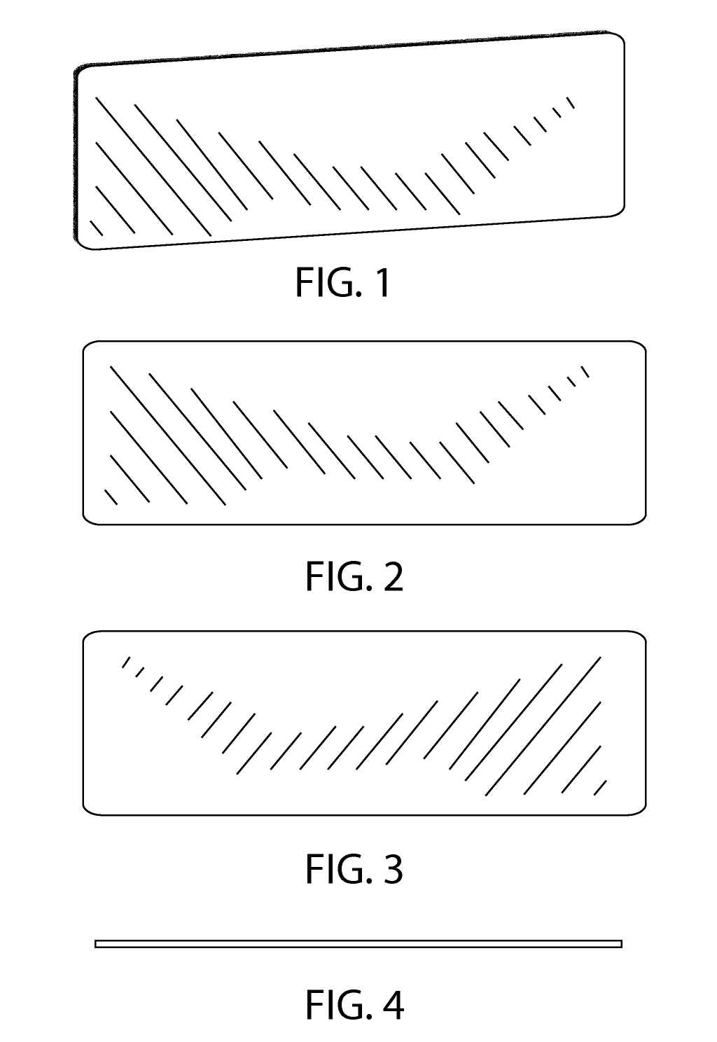

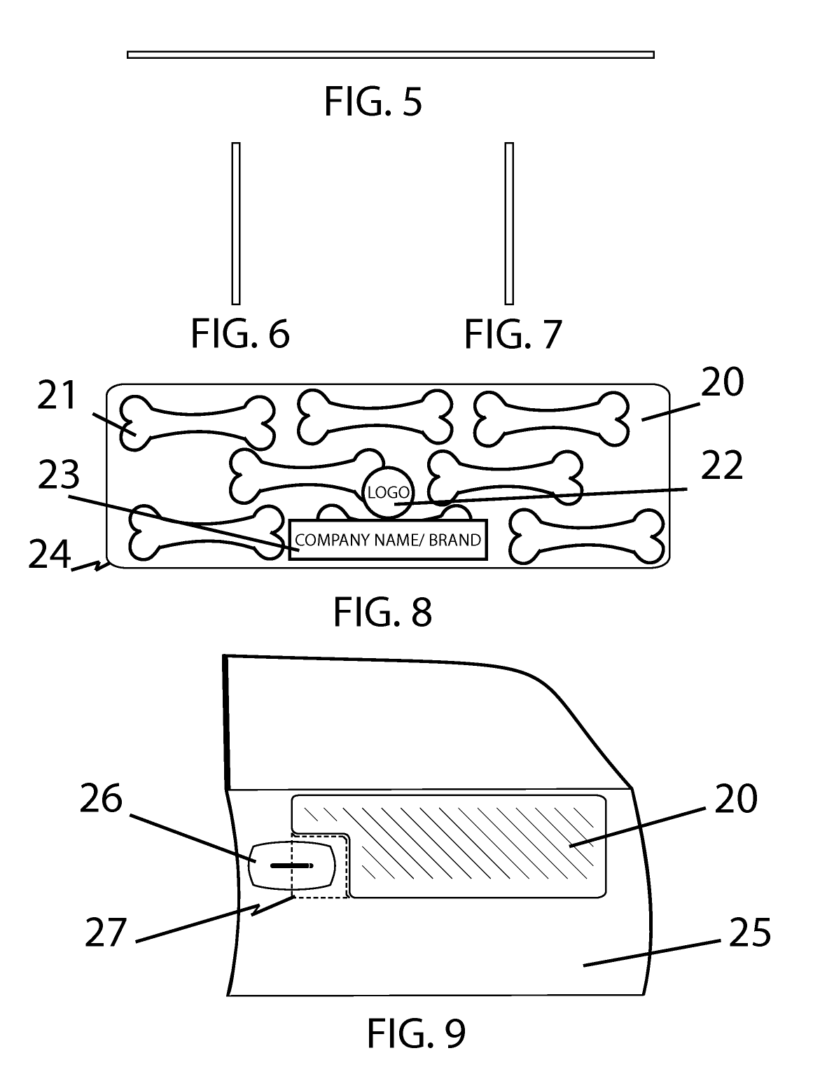

With reference to FIG. 1, an embodiment of the present invention is preferably comprised of a rectangular shaped single sheet of magnetized flexible substrate with a vinyl covering and of sufficient magnetic force to adhere to a vehicle's ferrous metal body panel and remain adhered to the body panel at highway speeds, thus creating a protector for the vehicle body panel. This protector would be removable, repositionable and replaceable, to facilitate cleaning of the vehicle body panel and the protector, and to facilitate storage of the protector when protection of the vehicle body panel is not required.

With reference to FIG. 8, the protector (20) is decorated with a preferred example of a visual design (21) to enhance the aesthetic appeal and appearance of the protector. To provide such a layer of visual design any suitable technique may be used such as digital printing, laser printing, ink-jet printing, offset printing, label printing, or colored laminates can be applied to the protector, and in various forms of visual design to match or complement the vehicle body panel. The visual design can cover any portion of the protector depending on the desired aesthetic affect.

With reference to FIG. 8, a logo design (22) or company name or brand (23) may be applied to the protector using any suitable technique such as digital printing, laser printing, ink-jet printing, offset printing, label printing, or by applying colored laminates.

With reference to FIG. 8, the protector (20) has rounded corners (24) to reduce the aerodynamic drag of the protector and to ensure the protector does not separate from the vehicle's ferrous metal body panel at highway speed.

With reference to FIG. 9, the protector (20) is adhered by magnetic force to a vehicle's ferrous metal body panel (25), in this example a car door, and directly below the window opening of the car door, to protect the car door from scratches and abrasions caused by animal or human extremities protruding through the open car door window, and resting in the car door surface.

With reference to FIG. 8, the protector (20) is also trimmed to fit around an object protruding from the vehicle body panel, in this example a car door handle (26), by removing a section of the protector (27), represented by the shape outlined by the dotted line. This section of the protector (27) may be removed by means of die cutting or trimming with a suitable utility knife or shears and in such a way as to maintain rounded corners.

With respect to the foregoing and as described in the embodiments and illustrated above, it is to be realized that numerous variations and modifications may be effected by those skilled in the art without departing from the spirit and scope of the invention. It is also understood that while the construction and operation has been described above, it is illustrative only of the principles of the invention and not a definition of the invention.

What is claimed is:

1. A magnetic attachable and removable protector for temporary installation to a vehicle body panel to protect said vehicle body panel from scratches and abrasions, comprising:
(a) a single sheet of substrate having;
(b) rounded corners;
(c) a printable surface;
(d) a composition suitable for trimming;

2. The protector of claim 1, wherein the single sheet of substrate is magnetized to adhere to a ferrous metal vehicle body panel by magnetic force.

3. The protector of claim 2, wherein the single sheet of magnetized substrate is flexible and pliable to adhere to the contour of a ferrous metal vehicle body panel by magnetic force.

4. The protector of claim 3, wherein the corners of the magnetized flexible substrate are rounded to reduce aerodynamic drag.

5. The protector of claim 4, wherein the magnetic force and aerodynamic properties are sufficient to adhere to a vehicle body panel at highway speed.

6. The protector of claim 1, wherein the surface can have a visual design, company name, brand and logo applied to it by a suitable technique such as digital printing, laser printing, ink-jet printing, offset printing, label printing, or colored laminates.

7. The protector of claim 1, wherein the composition of the substrate is suitable for trimming with a utility knife or shears.
